(19) United States
(12) Patent Application Publication
(10) Pub. No.: US 2006/0191021 A1
(43) Pub. Date: Aug. 24, 2006

(54) Authentication method in data storing apparatus and recording medium storing the same

(75) Inventors: Seung-youl Jeong, Hwaseong-si (KR); Jong-lak Park, Suwon-si (KR); Sung-youn Cho, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD.

(21) Appl. No.: 11/283,757

(22) Filed: Nov. 22, 2005

(30) Foreign Application Priority Data
Nov. 22, 2004 (KR) 10-2004-0095892

(51) Int. Cl. H04N 7/16

(52) U.S. Cl. 726/29

(57) ABSTRACT

Provided is a data storing apparatus for recording data processed by a host system, and more particularly, to an authentication method of determining legality of the host system for accessing the data storing apparatus and recording medium storing the same. The authentication method includes: checking a connection elapsed time with the host system; when the connection elapsed time exceeds a predetermined time period, requesting the data storing apparatus to authenticate the host system; and determining to allow the host system to access the data storing apparatus according to the authentication result. According to the authentication method, the data storing apparatus counts the connection elapsed time with the host system, and authenticates the host system if the connection elapsed time exceeds a predetermined time period, thereby preventing the data storing apparatus from illegally being accessed by an authorized host system after the host system authenticates the data storing apparatus.

### CROSS-REFERENCE TO RELATED APPLICATIONS

This application claims the benefit of Korean Patent Application No. 10-2004-0095892, filed on Nov. 22, 2004, in the Korean Intellectual Property Office, the disclosure of which is incorporated herein by reference.

### BACKGROUND OF THE INVENTION

1. Field of the Invention

The present invention relates to a data storing apparatus for recording data processed by a host system, and more particularly, to an authentication method for determining legality of a host system accessing the data storing apparatus and a recording medium storing the same.

2. Description of the Related Art

Examples of an image signal receiving apparatus provided with recording media for storing image signals include a settop box (STB) having a hard disk drive (HDD), a CD recording device or a DVD recording device, a personal video recorder (PVR), a monitor, a personal computer (PC), a VCR and the like.

The STB is generally used for a video-on-demand (VOD) service. The VOD service is not a one-sided method in which data stream is transferred from a broadcast station to a user, but allows a user to directly select contents stored in a media database (MDB) to watch a favorite program at any time. The basic system for this VOD service includes a video source system provided with a video server, a subscriber's terminal such as an STB, and a network.

FIG. 1 illustrates a configuration of a general VOD service. The VOD service is provided using an MDB 102, a video server 104, a basic communication network 106, a subscriber network 108, a STB 110, and the like.

The video server 104 performs the following functions: (1) receiving, processing and managing a user's request, (2) storing large amounts of digital video data, (3) multiple input/output, (4) database management, and (5) recovering faults.

The STB 110 performs the following functions: (1) connecting a user to a subscriber network, (2) decompressing compressed video data, and (3) security and reservation. An STB for recording VOD service data is disclosed in Korean Patent Laid-Open Publication no. 1997-4852 (Jan. 29, 1997). In this publication, the STB can store VOD service data provided from a service provider on its HDD and allows a user to replay at anytime the VOD service data stored on the HDD after the communication with the service provider has finished.

FIG. 2 illustrates an exemplary STB provided with a hard disc drive. In FIG. 2, the STB 200 comprises a system controller 204, an interface 206, an MPEG decoder 208, a digital-to-analog converter (hereinafter, referred to as DAC) 210 and a HDD 212. The system controller 204 controls the operation of the STB 200 of FIG. 3 according to a user control command received through a remote controller receiver 202. The interface 206 is connected to a video server 104 shown in FIG. 1 under the control of the system controller 204. The MPEG decoder 208 decodes the MPEG-compressed data transmitted from the video server 104 and restores video and audio data. The DAC 210 converts the restored video and audio data into an analog signal so as to output the converted analog signal through a TV set or a monitor. The HDD 212 stores the MPEG-compressed data transmitted from the video server 104, or reproduces the stored MPEG-compressed data to provide the stored MPEG-compressed data to the MPEG decoder 208.

The apparatus shown in FIG. 2 stores the VOD service data provided from the video server 104 on its HDD and allows the user to replay the VOD service data stored on the HDD after the communication with the video server 104 has finished.

It is necessary to prevent data stored on the HDD of the STB from being illegally used, so that authentication is required between the HDD and the host system.

FIG. 3 is a flowchart illustrating a conventional hard disk drive authentication method disclosed in Korean Paten Laid-Open Publication No. 1998-4630 (Mar. 30, 1998). In FIG. 3, when power is supplied to a host computer, a password input by a user is transmitted to a HDD. When the password is identical to a registered password, the HDD is changed into a normal mode, thereby allowing the host computer to perform a next operation. When the password is not identical to the registered password, and the number of new passwords inputted by the user exceeds an established number, the HDD is changed into an abnormal mode, thereby not allowing the host computer to perform the next operation.

FIG. 4 is a block diagram of another conventional hard disk drive authentication method disclosed in Japanese Patent Laid-Open Publication No. 2004-70875 (Mar. 4, 2004). In FIG. 4, a secure system comprises an authentication server 1, a plurality of user devices 2, and a network 3 such as Internet. The plurality of user devices 2 comprise host computers 21 having a network-connected device, and hard disk drives 22 used as an external recording devices respectively.

The authentication server 1 stores IDs of the hard disk drives 22 and IDs of the host computers 21. When the host computers 21 access the hard disk drives 22, the host computers 21 transmit ID authentication requests regarding the hard disk drives 22 and the host computers 21 to the authentication server 1. The authentication server 1 performs authentication based on registered information, and transmits an authentication key to the host computers 21 after performing authentication successfully. The host computers 21 access hard disk drives 22 using the authentication key, and read data from the hard disk drives 22.

In the conventional hard disk drive authentication methods, the hard disk drive is authenticated when a host system is initially power-on or accesses the hard disk drive in order to prevent data stored on the hard disk drive from being accessed by an authorized user.

However, after authentication is successfully performed, authentication is no longer required, or re-authentication is performed by the host system. That is, no authentication is performed by the hard disk drive.

When the host system changes after authentication is performed by the host system, the hard disk drive is accessed by the changed host system.

More specifically, even if the host system performs re-authentication of the hard disk drive after the host system and the hard disk drive authenticate each other, the hard disk drive does not perform re-authentication and thus the host system is not authenticated.

Supposing that a cable for connecting the host system and the hard disk drive is separated from the host system and connected to another host system, since the hard disk drive re-authenticates another host system, the hard disk drive can be illegally accessed by another host system, i.e., an authorized host system.

### SUMMARY OF THE INVENTION

Accordingly, it is an aspect of the present invention to provide a method of authenticating a host system by a data storing apparatus connected to the host system.

Another aspect of the present invention is achieved by providing a recording medium for storing a program suitable for the method.

According to an aspect of the present invention, there is provided a method of authenticating a host system by a data storing apparatus accessed by the host system, the method including checking a connection elapsed time with the host system, requesting the data storing apparatus to authenticate the host system when the connection elapsed time exceeds a predetermined time period, and determining to allow the host system to access the data storing apparatus according to an authentication result.

The checking of the connection elapsed time may include counting commands inputted by the host system and further counting a duration time while a command is not inputted by the host system.

According to another aspect of the present invention, there is provided a computer readable recording medium storing a program of a method of authenticating a host system by a data storing apparatus accessed by the host system, the method including checking a connection elapsed time with the host system, requesting the data storing apparatus to authenticate the host system when the connection elapsed time exceeds a predetermined time period, and determining to allow the host system to access the data storing apparatus according to an authentication result.

Another aspect of the present invention is achieved by providing an apparatus, including a host system to input commands via a host interface circuit, a command counter to count the inputted commands and an idle timer to count duration time while commands are not inputted, a controller to send an authentication result to the host system when the command counter exceeds a predetermined command limit or when the idle timer exceeds a predetermined time limit, and a disk drive to permit access to the host system according to the authentication result.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a conventional configuration of a general VOD service;

FIG. 2 illustrates a conventional settop box provided with a hard disc drive;

FIG. 3 is a flowchart illustrating a conventional hard disk drive authentication method;

FIG. 4 is a block diagram of another conventional hard disk drive authentication method;

FIG. 5 is a flowchart of an authentication method according to the present invention;

FIG. 6 is a block diagram illustrating an authentication performed between a host system and a hard disk drive via a serial interface;

FIG. 7 is a block diagram of an authentication performed between the host system and the hard disk drive of FIG. 6, using a 20^{th} pin of an integrated drive electronics (IDE) cable; and

FIG. 8 is a diagram of a hard disk drive according to an embodiment of the present invention.

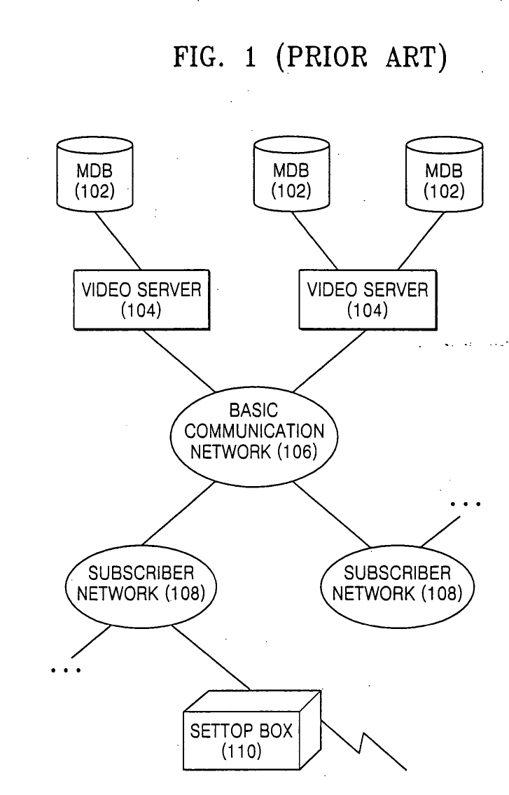

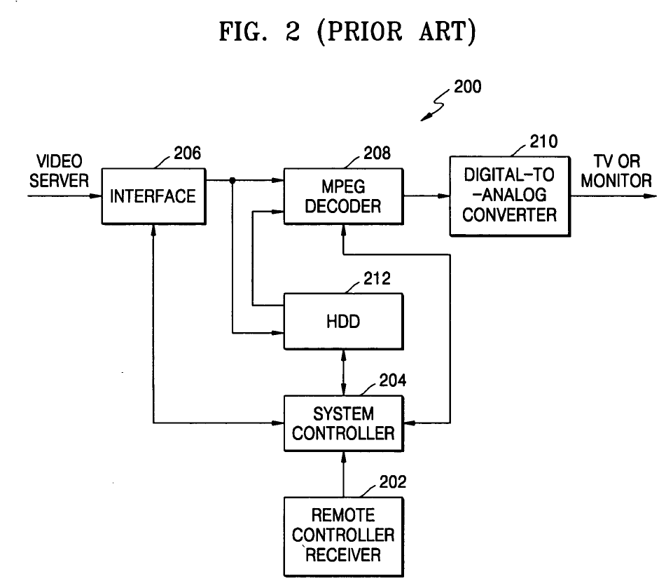

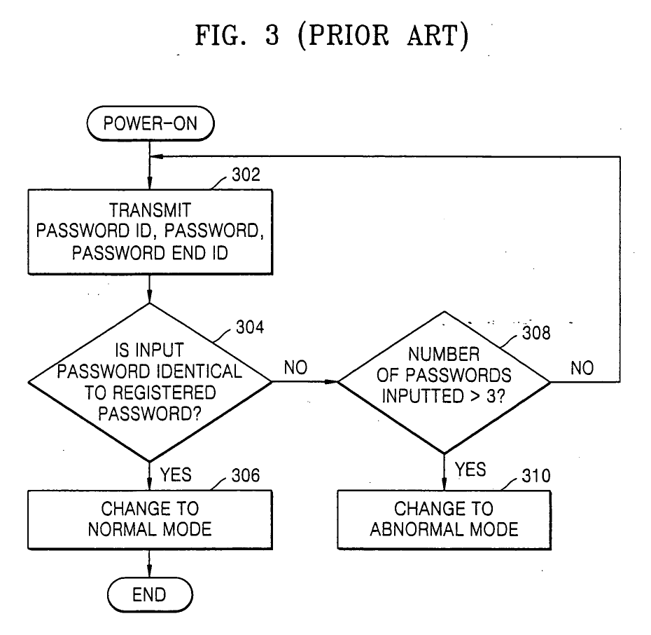

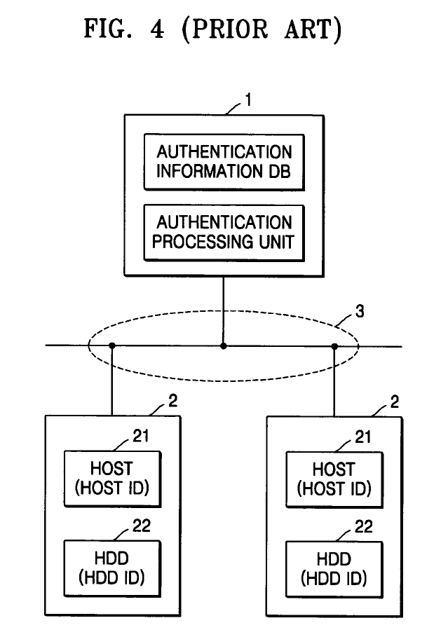

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

A data storing apparatus according to the present invention may be a hard disk drive, a CD player, a DVD player, a PVR, and the like.

According to an authentication method of the present invention, a data storing apparatus detects a connection elapsed time with a host system after completing a previous authentication. The connection elapsed time may be the number of commands inputted by the host system, an idle duration time, etc. When the connection elapsed time exceeds a predetermined time period, the data storing apparatus request the host system for authentication. When authentication is successfully completed, the host system is allowed to access the data storing apparatus. When the authentication is not successfully completed, the host system is not allowed to access the data storing apparatus.

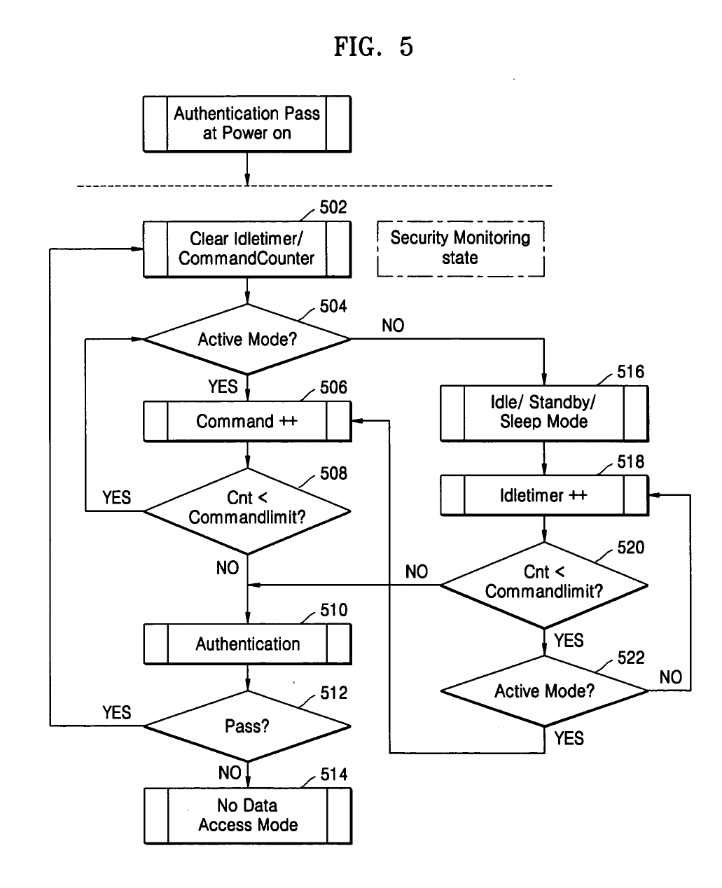

FIG. 5 is a flowchart of the authentication method according to the present invention. When the host system is turned on, authentication is performed between the host system and hard disk drive.

In FIG. 5, the hard disk drive clears an idle timer and a command counter in Operation 502. The idle timer is used to detect the idle duration time, and the command counter is used to count the number of commands inputted by the host system. The hard disk drive determines whether it is in an active mode in Operation 504. If the hard disk drive is in an active mode, the hard disk drive increases the command counter by 1 whenever the host system inputs a command in Operation 506. The hard disk drive checks whether a command counter value is more than a command limit in Operation 508.

If the command counter value is less than the command limit, the hard disk drive returns to Operation 504. If the command counter value is more than the command limit, the hard disk drive performs authentication of the host system in Operation 510.

The hard disk drive determines whether the authentication is successfully performed in Operation 512. If the hard disk drive successfully performs the authentication, the hard disk drive returns to Operation 502 and clears the idle timer and the command counter. If the hard disk drive fails to perform the authentication, the host system is not allowed to access the hard disk drive in Operation 514.

If the hard disk drive is in an inactive mode in Operation 504, the hard disk drive performs in the idle mode, a standby mode, or a sleep mode in Operation 516. The hard disk drive is established as one of the idle mode, the standby mode, or the sleep mode according to the inactive mode duration time.

The hard disk drive increases the idle counter by 1 in Operation 518. The hard disk drive checks whether an idle counter value is more than a time limit in Operation 520. If the idle counter value is less than the time limit, the hard disk drive determines whether it is in the active mode in Operation 522. If the hard disk drive is in the inactive mode, the hard disk drive returns to Operation 518, and continues to count the inactive mode duration time. If the hard disk drive is in the active mode, the hard disk drive returns to Operation 506, and the counts commands inputted by the host system. If the idle counter value is more than the time limit, the hard disk drive returns to Operation 510 and performs authentication of the host system.

The hard disk drive authenticates the host system when the command counter or the idle timer exceeds the command limit or the time limit. The hard disk drive allows the host system to access it according to whether the authentication is successfully performed or not. If the host system is an authorized system, since the host system informs the hard disk drive of the successful authentication, and then, the host system is allowed to access the hard disk drive. If the host system is not an authorized system, the host system fails to inform the hard disk drive of the successful authentication, and the host system is not allowed to access the hard disk drive. After the authorized host system authenticates the hard disk drive, even if the hard disk drive is connected to another host system using a cable, another host system is unable to authenticate the hard disk drive, thereby preventing another host system from illegally accessing the hard disk drive and protecting data stored on the hard disk drive.

When the hard disk drive transmits an authentication request signal to the host system, the host system transmits a signal in response to the authentication request signal, or authenticates an authentication key included in the hard disk drive and the host system.

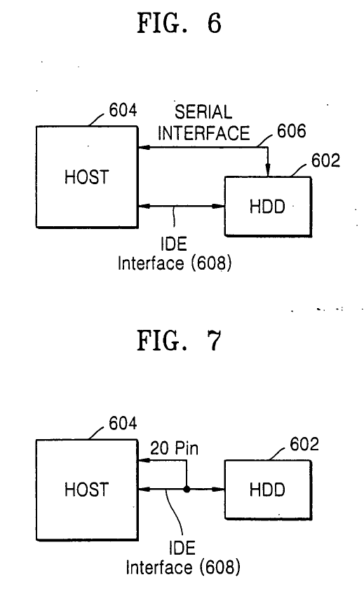

FIG. 6 is a block diagram of an authentication performed between the host system and the hard disk drive via a serial interface. When the command counter or the idle timer exceeds the command limit or the time limit, the hard disk drive 602 sends an authentication result to the host system 604 via the serial interface. The host system 604 is authenticated in response to the authentication request of the hard disk drive 602, and transmits an authentication result to the hard disk drive 602 via the serial interface 606. The hard disk drive 604 allows the host system 604 to access it according to the authentication result.

FIG. 7 is a block diagram of an authentication performed between the host system and the hard disk drive of FIG. 6, using a 20^{th} pin of an integrated drive electronics (IDE) cable. According to the AT Attachment Peripheral Interface (ATAPI) specification, the 20^{th} pin of the IDE cable is not used to transmit a signal. The host system and the hard disk drive perform authentication by transmitting/receiving a predetermined signal using the 20^{th} pin.

When the command counter or the idle timer exceeds the command limit or the time limit, the hard disk drive 602 sends an authentication result to the host system 604 via the 20^{th} pin. The host system 604 is authenticated in response to the authentication request of the hard disk drive 602, and transmits an authentication result to the hard disk drive 602 using the 20^{th} pin. The hard disk drive 604 allows the host system 604 to access it according to the authentication result.

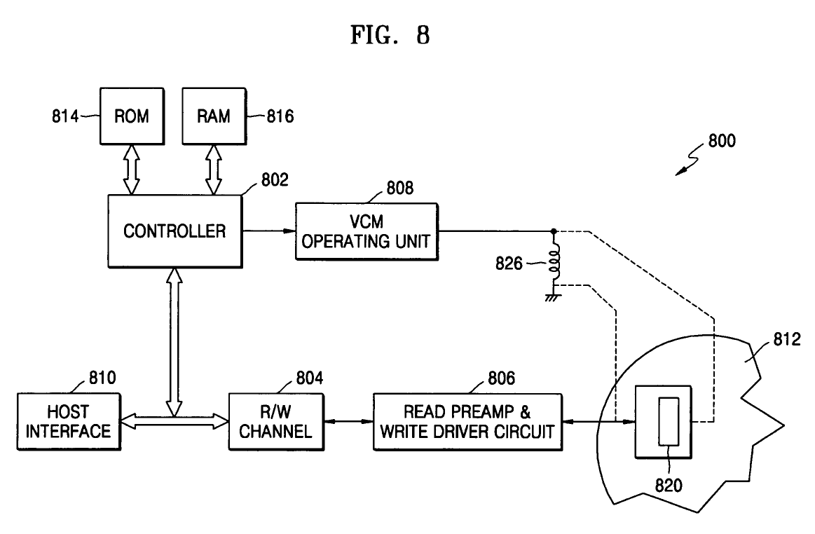

FIG. 8 is a diagram of the hard disk drive according to an embodiment of the present invention. In FIG. 8, the hard disk drive includes a controller 802 connected to a head 820 using a read/write (R/W) channel circuit 804 and a read preamp & write driver circuit 806. The controller 802 may be a digital signal processor (DSP), a microprocessor, a micro controller, etc.

The controller 802 supplies a control signal to the R/W channel circuit 804 in order to read data from the hard disk drive 812 or write data to the hard disk drive 812. The R/W channel circuit 804 transmits data to a host interface circuit 810. The host interface circuit 810 includes a control circuit in order to interface a system such as a personal computer.

The R/W channel circuit 804 modulates an analog signal read by the head 820 and amplified in the read preamp & write driver circuit 806 into a digital signal read by the host computer (not shown), outputs the digital signal to the host interface circuit 810, receives user data from the host computer via the host interface circuit 810, converts user data into a write current written to the hard disk drive 812, and outputs the write current to the read preamp & write driver circuit 806 in a generation mode.

The controller 802 is connected to a VCM operating circuit 808 for supplying an operating current to a voice coil 826. The controller 802 supplies the control signal to the VCM operation circuit 808 in order to control VCM excitation and head motion.

The controller 802 is connected to a nonvolatile memory such as a ROM 814 or a flash memory, and a RAM 816. The ROM 814 and RAM 816 include commands and data used to execute a software routine by the controller 802.

One of the software routine is a program for executing the authentication method according to an embodiment of the present invention. The program is stored in the nonvolatile memory.

The controller 802 counts commands inputted by the host computer via the host interface circuit 810 using the command counter, or counts a duration time while the command is not inputted using the idle timer.

When the command counter or the idle timer exceeds the command limit or the time limit, the controller 802 sends an authentication result to the host system 604 using the serial interface or the 20^{th} pin. The hard disk drive 602 allows the host system 604 to access it according to the authentication result. If the host system is an authorized system, the command counter or the idle timer is cleared, and the host system is allowed to access the hard disk drive 602. If the host system 604 is not an authorized system, the host system 604 is not allowed to access the hard disk drive.

The present invention may be carried out in the form of a method, a device or a system. When the present invention is carried out in the form of software, the elements of the present invention are essential code segments which perform necessary tasks. The program and code segments may be stored on a processor readable medium and transmitted in the form of a computer data signal coupled with a carrier wave in transmission media or communication network. The processor readable medium may be any medium through which information can be stored or transmitted. Examples of the processor readable medium include electronic circuit, semiconductor memory device, read-only memory (ROM), flash memory, erasable ROM (EROM), floppy disks, optical data storage devices, hard disks, optical fiber medium, radio frequency network, and the like. The computer data signal may be any signal that can be transmitted through transmission medium such as electronic network channel, optical fiber, air, electromagnetic field, radio frequency network, and the like.

According to the authentication method of the present invention, a data storing apparatus counts a connection elapsed time with a host system, and authenticates the host system if the connection elapsed time exceeds a predetermined time period, thereby preventing the data storing apparatus from illegally being accessed by an authorized host system after the host system authenticates the data storing apparatus.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of authenticating a host system by a data storing apparatus accessed by the host system, the method comprising:
checking a connection elapsed time with the host system;
requesting the data storing apparatus to authenticate the host system when the connection elapsed time exceeds a predetermined time period; and
determining whether to allow the host system to access the data storing apparatus according to an authentication result.

2. The method of claim 1, wherein the checking of the connection elapsed time comprises:
counting commands inputted by the host system.

3. The method of claim 1, wherein the checking of the connection elapsed time further comprises:
counting a duration time while a command is not inputted by the host system.

4. The method of claim 1, wherein the requesting comprises:
requesting the data storing apparatus to authenticate the host system via a serial interface.

5. The method of claim 3, wherein the requesting authentication comprises:
requesting the data storing apparatus to authenticate the host system using a cable used to transmit data between the data storing apparatus and the host system.

6. The method of claim 5, wherein the cable is an integrated drive electronics (IDE) cable, and data is transmitted using a 20^{th} pin of the IDE cable.

7. A computer readable recording medium storing a program of a method of authenticating a host system by a data storing apparatus accessed by the host system, the method comprising:
checking a connection elapsed time with the host system;
requesting the data storing apparatus to authenticate the host system when the connection elapsed time exceeds a predetermined time period; and
determining to allow the host system to access the data storing apparatus according to the authentication result.

8. The computer readable recording medium of claim 7, wherein the checking of the connection elapsed time comprises:
counting commands inputted by the host system.

9. The computer readable recording medium of claim 7, wherein the checking of the connection elapsed time further comprises:
counting a duration time while a command is not inputted by the host system.

10. An apparatus, comprising:
a host system to input commands via a host interface circuit;
a command counter to count the inputted commands and an idle timer to count duration time while commands are not inputted;
a controller to send an authentication result to the host system when the command counter exceeds a predetermined command limit or when the idle timer exceeds a predetermined time limit; and
a disk drive to permit access to the host system according to the authentication result.

11. The apparatus of claim 10, wherein the command counter or the idle timer is cleared if the host system is an authorized system, and the host system is permitted to access the disk drive.

12. The apparatus of claim 10, wherein the host system is not allowed to access the disk drive if the host system is not an authorized system.

13. The apparatus of claim 11, wherein an authorized system is determined based on the authentication result.

14. The apparatus of claim 12, wherein an authorized system is determined based on the authentication result.
